(19) United States
(12) Patent Application Publication
(10) Pub. No.: US 2012/0075056 A1
(43) Pub. Date: Mar. 29, 2012

(54) FACILITY CONTROLLING SYSTEM AND METHOD

(75) Inventor: Tomoyuki Tada, Tokyo (JP)

(73) Assignee: YAMATAKE CORPORATION, Tokyo (JP)

(21) Appl. No.: 13/238,209

(22) Filed: Sep. 21, 2011

(30) Foreign Application Priority Data
Sep. 27, 2010 (JP) 2010-214862

(51) Int. Cl. G08B 29/00

(52) U.S. Cl. 340/5.2

(57) ABSTRACT

When an evaluation result by an evaluation processing portion indicates that entry is authorized, the evaluation processing portion obtains a resident region of the user from a user information storing portion and obtains a movement destination resident user count of the movement destination region of the user from a region information storing portion, and if the user is a resident user of the movement destination region and the movement destination resident user count prior to entry by the user is zero, instructs an equipment operation controlling portion to start operation of the related equipment in the movement destination region.

### CROSS REFERENCE TO RELATED APPLICATIONS

The present application claims priority under 35 U.S.C, §119 to Japanese Patent Application No. 2010-214862, filed Sep. 27, 2010, which is incorporated herein by reference.

### FIELD OF TECHNOLOGY

The present invention relates to a facility controlling technology, and, in particular, relates to a facility controlling technology for controlling the operation of the related equipment that is related to the region at a time of an entry evaluation into a region provided in the facility.

### BACKGROUND OF THE INVENTION

In a facility controlling system for controlling entry/exit of users using a plurality of regions provided in a facility, recording media, such as ID cards, recorded with individual identification numbers for identification of individuals, are distributed in advance to users, and when a user enters any given region, an evaluation is made as to whether or not the entry/exit by the user is authorized, based on the individual identification number, which is read from the ID card by a reader terminal, such as a card reader, placed at the entrance/exit of the region, when a user is entering or exiting any given region, where an electric lock that is provided on a door of the region is unlocked depending on the evaluation that entrance/exit is not authorized.

Moreover, in this type of facility controlling system, the related devices that are related to each region are operated automatically in coordination with the entrances/exits to the regions, such as recording an entrance/exit history for each region, controlling the start and stop of operations of lighting equipment and air-conditioning equipment in each region when the first user first enters into the region for the last user exits from the region, turning on an alarm system for the region at quitting time, turning off the alarm system at the time of first arrival, and the like. See, also Japanese Unexamined Patent Application

Publication H11-210284.

In this type of facility controlling system, there has been a problem in that the related equipment will end up running even if the region is used only briefly, because of automatic operation of the related equipment that is related to the region depending on whether or not there is a user in the region, which is in efficient and uneconomic in terms of the operation of the facility.

For example, the operation of the lighting equipment and air-conditioning equipment of the region will be started up, even if the user moves temporarily for some reason to a region of a different department, or even if temporarily passes through a region of a different department.

The present invention is to solve this type of problem, and the object thereof is to provide a facility controlling technology wherein the equipment related to a region can be operated efficiently and economically in coordination with the entrance/exit of a user into/out of each individual region.

### SUMMARY OF THE INVENTION

In order to achieve the object set forth above, a facility controlling system according to the present invention for controlling the operation of related equipment that is related to a region at a time of an entry evaluation into a region provided in the facility, includes a region information storing portion for storing, for each region for which entry is controlled, a resident user count that indicates the number of resident users, for whom the region is a resident region, present in the region; a user information storing portion for storing, for each user who uses a region, a resident region that indicates a region wherein the user is normally present, and evaluation information for evaluating entry authorization into the region; a reader terminal, provided in each region, for sending an evaluation request for requesting an entry authorization evaluation for the user for the region in response to a user operation; and an evaluation processing portion for evaluating, in response to an evaluation request from a reader terminal, entry authorization of the user regarding the region based on evaluation information for the user obtained from the user information storing portion, and for instructing unlocking of an electric lock that is provided at the region and also updating, in the region information storing portion, resident user counts in a movement destination region and a movement origin region of the user, when the evaluation result is that entry is authorized; and an equipment operation controlling portion for controlling, for each region, operation of related equipment in coordination with use of that region; wherein: when an evaluation result by the evaluation processing portion indicates that entry is authorized, the evaluation processing portion obtains the resident region of the user from the user information storing portion and obtains the movement destination resident user count of the movement destination region of the user from the region information storing portion, and if the user is a resident user of the movement destination region and the movement destination resident user count prior to entry by the user is zero, instructs the equipment operation controlling portion to start operation of the related equipment in the movement destination region,

At this time, the evaluation processing portion, when the evaluation result indicates that entry is authorized, may obtain a movement origin resident user count, from the region information storing portion, of the movement origin region of the user, and if the user is a resident user of the movement origin region and the movement origin resident user after entry enter by the user will be zero, may instruct the equipment operation controlling portion to stop operation of the related equipment in the movement origin region,

Moreover, the evaluation processing portion, if the movement destination resident user count prior to entry by the user is zero and the user is not a resident user of the movement destination region when the evaluation result based on the evaluation information indicates that entry is authorized, may evaluate the entry of a user into the region as being non-authorized.

Moreover, a facility controlling method used in a facility controlling system for controlling the operation of related equipment that is related to a region at a time of an entry evaluation into a region provided in the facility, has a region information storing step wherein a region information storing portion stores, for each region for which entry is controlled, a resident user count that indicates the number of resident users, for whom the region is a resident region, present in the region; a user information storing step wherein a user information storing portion stores, for each user who uses a region, a resident region that indicates a region wherein the user is normally present, and evaluation information for evaluating entry authorization into the region; an operating step wherein a reader terminal, provided in each region, sends an evaluation request for requesting an entry authorization evaluation for the user for the region in response to a user operation; an evaluation processing step wherein an evaluation processing portion evaluates, in response to an evaluation request from a reader terminal, entry authorization of the user regarding the region based on evaluation information for the user obtained from the user information storing portion, and instructs the unlocking of an electric lock that is provided at the region and also updates, in the region information storing portion, resident user counts in a movement destination region and a movement origin region of the user, when the evaluation result is that entry is authorized; and an equipment operation controlling step wherein an equipment operation controlling portion controls, for each region, operation of related equipment in coordination with use of that region; wherein: when an evaluation result by the evaluation processing step indicates that entry is authorized, the evaluation processing portion obtains the resident region of the user from the user information storing portion and obtains the movement destination resident user count of the movement destination region of the user from the region information storing portion, and if the user is a resident user of the movement destination region and the movement destination resident user count prior to entry by the user is zero, instructs the equipment operation controlling portion to start operation of the related equipment in the movement destination region.

At this time, the evaluation processing step, when the evaluation result indicates that entry is authorized, may obtain a movement origin resident user count, from the region information storing portion, of the movement origin region of the user, and if the user is a resident user of the movement origin region and the movement origin resident user after entry enter by the user will be zero, may instruct the equipment operation controlling portion to stop operation of the related equipment in the movement origin region.

Moreover, the evaluation processing step, if the movement destination resident user count prior to entry by the user is zero and the user is not a resident user of the movement destination region when the evaluation result based on the evaluation information indicates that entry is authorized, may evaluate the entry of a user into the region as being non-authorized.

The present invention makes it possible to start operation of the related equipment in a movement destination region only when a user enters a movement destination region wherein there is no resident user of the movement destination region present. Doing so makes it possible to avoid starting the operation of the related equipment in the movement destination region when a user who is not a resident of the movement destination region enters into a movement destination region wherein there is no resident user of the movement destination region present, enabling the related equipment in the region to be operated more efficiently and more economically than in a case wherein the related equipment that is related to the region is operated automatically depending on whether or not an arbitrary user is present in the region.

### BRIEF DESCRIPTION OF THE DRAWINGS

FIG. 1 is a Hock diagram illustrating a structure of a facility controlling system according to an example.

FIG. 2 is a structural example of region information.

FIG. 3 is a structural example of user information.

FIG. 4 is a flowchart illustrating the entry evaluation operation of the facility controlling system according to the example.

FIG. 5 is an explanatory diagram illustrating an example entry evaluation operation of the facility controlling system according to the example.

FIG. 6 is an explanatory diagram illustrating another example entry evaluation operation of the facility controlling system according to the example.

FIG. 7 is a flowchart illustrating the entry evaluation operation of the facility controlling system according to another example.

FIG. 8 is an explanatory diagram illustrating an example entry evaluation operation of the facility controlling system according to the other example.

FIG. 9 is an explanatory diagram illustrating another example entry evaluation operation of the facility controlling system according to the other example,

### DETAILED DESCRIPTION OF THE INVENTION

Forms for carrying out the present invention are explained next in reference to the figures,

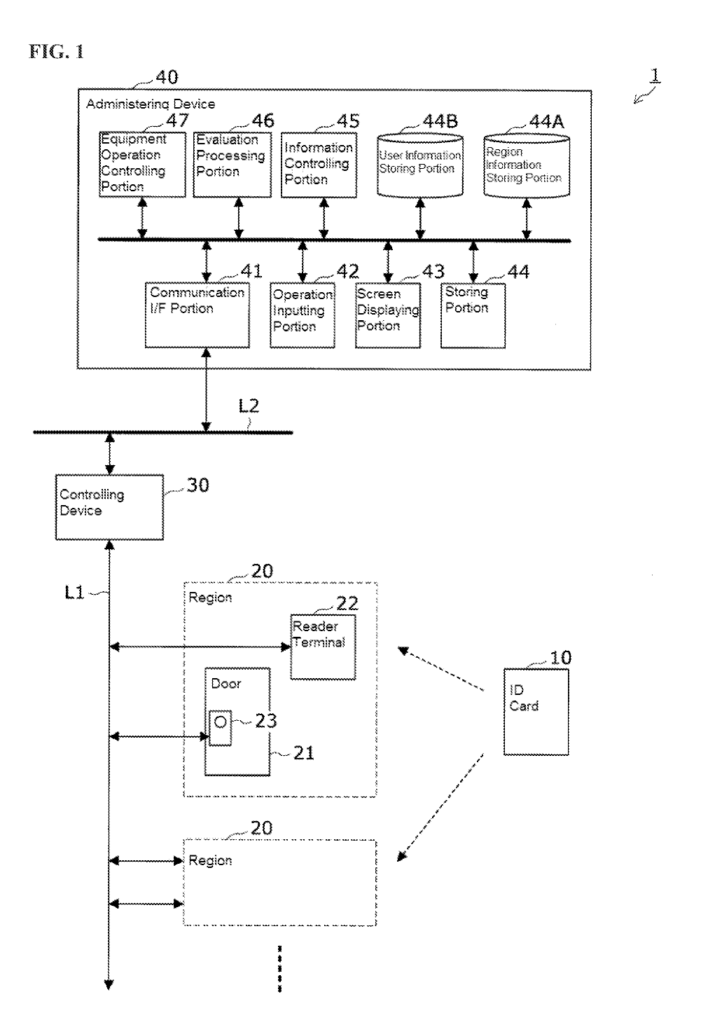

First of all, a facility controlling system according to an example is explained in reference to FIG. 1. FIG. 1 is a block diagram illustrating a structure of a facility controlling system according to an example.

The facility controlling system I includes an ID card 10, a reader terminal 22, and electric lock 23, a controlling device 30, and an administering device 40. The reader terminal 22 and the electric lock 23 that are provided for the door 21 of each region 20 are connected to the controlling device 30 through a communication circuit LI so as to be able to exchange data. Moreover, the administering device 40 is connected through a communication circuit L2 so as to be able to exchange data with the controlling device 30. In this case, a plurality of controlling devices 30 may be provided, depending on the scope of the facility controlling system.

The ID card 10 includes a mobile card for data processing, such as a memory card or an IC card, and has a function for recording user identification information, such as a user ID that is permanent for the user, as information required for evaluating whether or not the user who has the ID card is allowed to pass.

The reader terminal 22 comprises a card processing device such as a card reader, provided in parallel with each door 21 of a region 20, and having a function for reading user identification information, such as a user ID, from the ID card 10 presented by the user, through inserting the ID card into a card slot (contact type) or through holding the ID card up to a card antenna (non-contact type), and a function for sending, through the communication circuit Li to the controlling device 30, an evaluation request that includes the user identification information and a door ID that is unique to the applicable door 21 and that is set locally in advance,

The electric lock 23 has a function for performing unlocking/locking of a door 21 in accordance with an instruction for unlocking/locking from the controlling device 30, received through the communication circuit L1 and comprises an electrically actuated lock, and is provided for each door 21 of a region 20. Note that the electric lock 23 is usually locked, and is unlocked for only a specific period of time when an unlock instruction arrives from the controlling device 30,

The controlling device 30 has a limiting device such as a controller, use in various types of control systems that perform control and monitoring of a facility and is provided with a function for receiving, through the communication circuit L1, evaluation requests from the reader terminals 22 that are provided at each of the regions 20 and for reporting to the administering device 40 through the communication circuit L2, and a function for controlling the electric lock 23, which is provided at the door 21 of the corresponding region 20, in response to an instruction from the administering device 40.

The administering device 40 is, overall, an information processing device such as a server device or a PC, and has a function for evaluating the entry/exit authorization of the user for the particular region, in accordance with the evaluation request from the reader terminal 22 through the controlling device 30, to perform unlock control of the doors of the various regions, and a function for controlling the operation of related equipment to coordinate with the use of the individual regions.

As the main functional portions, the administering device 40 is provided with a communication I/F portion 41, an operation inputting portion 42, a screen displaying portion 43, storing portion 44, a region information storing portion 44A, a user information storing portion 44B, an information controlling portion 45, an evaluation processing portion 46, and an equipment operation controlling portion 47, where these functional portions are connected to each other through an internal bus so as to enable the exchange of data.

The communication I/F portion 41 has the function of performing data communication with the external devices, such as the controlling device 30, through a communication circuit L2.

The operation inputting portion 42 is made from an operation inputting device, such as a keyboard or a mouse, and has a function for detecting operations by an operator and outputting them to various types of functional portions, such as the information controlling portion 45.

The screen displaying portion 43 is made from a screen displaying device, such as an LCD or a PDP, and has a function for displaying on a screen various types of information outputted from various types of functional portions, such as the information controlling portion 45.

The storing portion 44 comprises a storage device such as a memory or a hard disk, and has a function for storing the various types of data and programs used in the processing operations by the administering device 40.

The region information storing portion 44A is a storing device, such as a memory or a hard disk, that is a storing portion for storing, as region information for each of the regions 20 for which entry/exit is controlled, a combination of a region ID for identifying the region and a resident user count indicating the number of resident users, within the region 20, for whom the region 20 is their resident region.

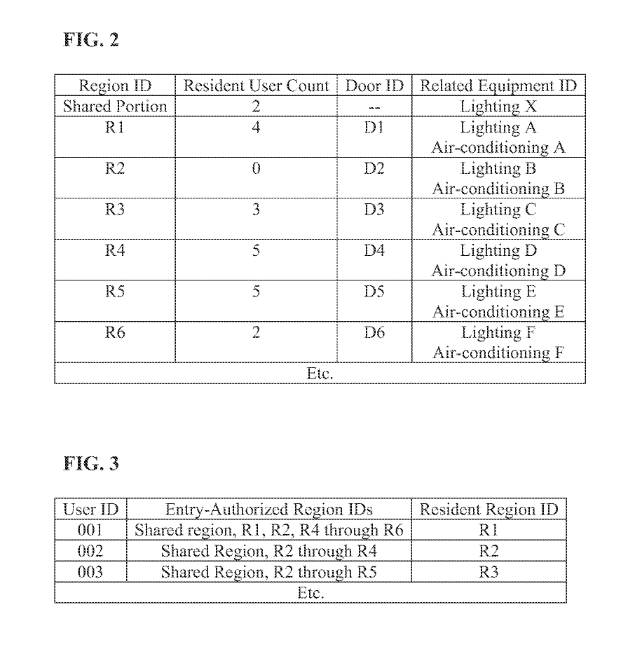

FIG. 2 is a structural example of region information. Here a combination of the region ID and the resident user count, a door ID of a door 21 that is provided at the region 20, and a related equipment ID indicating the equipment that should be operated in coordination with the use of the region 20 is stored for each region 20.

The user information storing portion 44B includes a storage device such as a memory or a hard disk, and is a storing portion for storing, for each individual user that uses the region 20, a combination of the user identification information such as a user ID for identifying the user, evaluation information, such as an entry-permitted region ID for evaluating the entrance authorization for the user for each individual region, and a resident region ID indicating the regions of which the user is a. resident. A resident region is a region that is the whereabouts of the user in the normal state, such as a region wherein the desk of the user is located, and may be determined by, for example, the department to which the user belongs.

FIG. 3 is a structural example of user information. Here a user ID, an entry-authorized region ID indicating, as evaluation information, regions for which entry is authorized, and a resident region ID are recorded for each user.

The information controlling portion 45 is structured from a calculation processing portion wherein a CPU and a program work together cooperatively, and has a function for changing and storing region information that is stored in the region information storing portion 44A in accordance with region information changing operations by an operator through the operation inputting portion 42, and a function for changing and storing user information that is stored in the user information storing portion 44B in accordance with user information changing operations by an operator through the operation inputting portion 42,

The evaluation processing portion 46 is structured from a calculation processing portion wherein a CPU and a program work together cooperatively, and has a function for comparing, in response to an evaluation request from a reader terminal 22, received through the controlling device 30 and the communication I/F portion 41, the region ID of the applicable region 20, obtained from the region information storing portion 44A based on the door ID specified in the evaluation request, and the entrance-permitted region IDs of the user, obtained from the user information storing portion 44B based on the user ID specified in the evaluation request, to evaluate the authorization of entry into the region 20 for the user in accordance with the comparison results, a function for directing the electric lock 23 of the region 20, from the communication I/F portion 41 and through the controlling device 30, to unlock the door, depending on the entry authorization evaluation result, and for updating the resident user count, in the region information storing portion, for the movement destination region and the movement of origin region of the user.

Moreover, the evaluation processing portion 46 has a function for obtaining the resident region ID of the user from the user information storing portion 44B and obtaining the movement destination resident user count in the movement destination region of the user, from the region information storing portion 44A, and if the user is a resident user of the movement destination region and if prior to entrance by the user, the movement destination resident user count is zero, instructing the equipment operation controlling portion 47 to start the operation of the related equipment in the movement destination region, when the evaluation result indicates that entrance is authorized, and a function for Obtaining the movement of origin resident user count in the movement origin region of the user from the region information storing portion 44A when the evaluation result indicates that entrance is authorized, and if the user is a resident user of the movement origin region and the movement origin resident user count, after entry by the user is zero, instructing the equipment operation controlling portion 47 to stop the operation of the related equipment in the movement origin region.

The equipment operation controlling portion 47 is structured from a calculation processing portion wherein a CPU and a program work together, and has a function for controlling the operation of related equipment in coordination with the use of the region 20, for each region 20, in accordance with instructions from an evaluation processing portion 46.

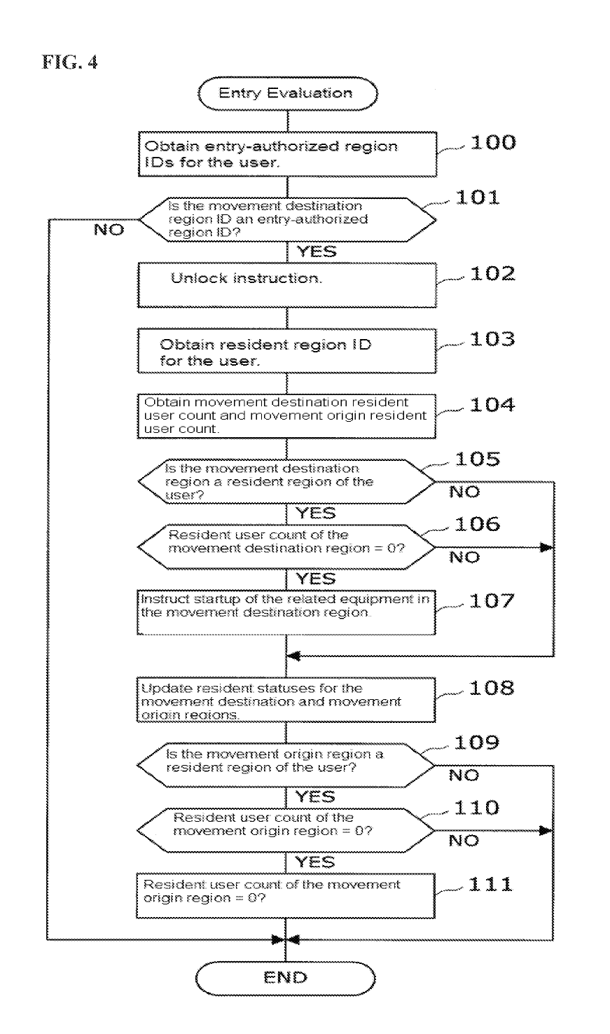

The entry evaluation operations of the facility controlling system according to the present example is explained next in reference to FIG. 4. FIG. 4 is a flowchart illustrating the entry evaluation operation of the facility controlling system according to the example.

The evaluation processing portion 46 of the administering device 40 performs the entry evaluation processes of FIG. 4 in response to an evaluation request from a reader terminal 22, received by the communication I/F portion 41 through the controlling device 30. First the evaluation processing portion 46 receives, from the user information storing portion 44B, the entry-permitted region IDs for the user, based on the user ID that is included in the evaluation request that has been received (Step 100), and compares it to a movement destination region ID that indicates a region 20 corresponding to a door ID, received from the region information storing portion 44A based on the door ID that is included in an evaluation request that, similarly, has been received (Step 101).

If here the movement destination region ID is not included in the entrance-authorized region IDs (Step 101: NO), then the entrance of the user for the movement destination region is evaluated as being unauthorized, and the series of entry evaluating processes is terminated. Doing so causes the electric lock 23 of the corresponding door 21 to remain locked, so that the user is unable to enter into the movement destination region.

On the other hand, if the movement destination region .ID is included in the entrance-authorized region IDs (Step 101: YES), then the evaluation processing portion 46 evaluates that the entry by the user into the movement destination region 20 is authorized, and sends an unlock instruction from the communication IT portion 41 through the controlling device 30 to the electric lock 23 of the corresponding door 21 (Step 102). Doing so causes the electric lock of the door 21 to be unlocked, enabling the user to enter into the movement destination region.

Thereafter, the evaluation processing portion 46 obtains the resident region ID of the user from the user information storing portion 44B (Step 103) and obtains, from the region information storing portion 44A, the movement destination resident user count, which is the number of resident users in the movement destination region, and the movement origin resident user count, which is the number of resident users in the movement origin (Step 104).

Following this, if the user is a resident user of the movement destination region (Step 105: YES), and the movement destination resident user count prior to the entry by the user is zero (Step 106: YES), then the evaluation processing portion 46 instructs the equipment operation controlling portion 47 to start the operation of the related equipment of the movement destination region based on the related equipment IDs of the movement destination region, obtained from the region information storing portion 44A (Step 107), and updates the number of resident users in the movement destination region and the movement origin region related to the entry by the user in the region information storing portion 44A (Step 108). As a result, the operation of the related equipment in the movement destination region is started by the equipment operation controlling portion 47.

On the other hand, if the user is not a resident user of the movement destination region (Step 105: NO), or the movement destination resident user count prior to the entry by the user is not zero (Step 106: NO), then the evaluation processing portion 46 jumps to Step 108 without instructing the equipment operation controlling portion 47 to start the operation of the related equipment in the movement destination region, to thereby update the number of resident users in the movement destination region and the movement origin region related to the entry by the user in the region information storing portion 44A.

As a result, if the status of the related equipment in the movement destination region prior to the entry is continued, for example, if there was a resident user in the movement destination region, the operation of the related equipment continues. Moreover, if there was no resident user in the movement destination region, then even if a user who is not a resident user of the movement destination region were to enter the movement destination region, the operation of the related equipment would not be started, and the stopped status would continue.

Following this, if the user is a resident user of the movement origin region (Step 109: YES), and the movement origin resident user count after the entry by the user is zero (Step 110: YES), then the evaluation processing portion 46 instructs the equipment operation controlling portion 47 to stop the operation of the related equipment of the movement origin region based on the related equipment IDs of the movement origin region, obtained from the region information storing portion 44A (Step 111), and terminates the series of entry evaluation processes. As a result, the operation of the related equipment of the movement origin region is stopped by the equipment operation controlling portion 47 after the entrance by the user into the movement destination region, even if there is, in the movement origin region, a user who is not a resident user of the movement origin region.

On the other hand, if the user is not a resident user of the movement origin region (Step 109: NO), or the movement origin resident user count after the entry of the user is not zero (Step 110: NO), then the evaluation processing portion 46 terminates the series of entry evaluation processes without instructing the termination of operation of the related equipment in the movement origin region.

As a result, if the status of the related equipment in the movement origin region prior to the entry is continued, for example, if a resident user remains in the movement origin region, the operation of the related equipment continues, and if the related equipment is not operating because there is no resident user in the movement origin region, the stopped state of operation of the related equipment continues.

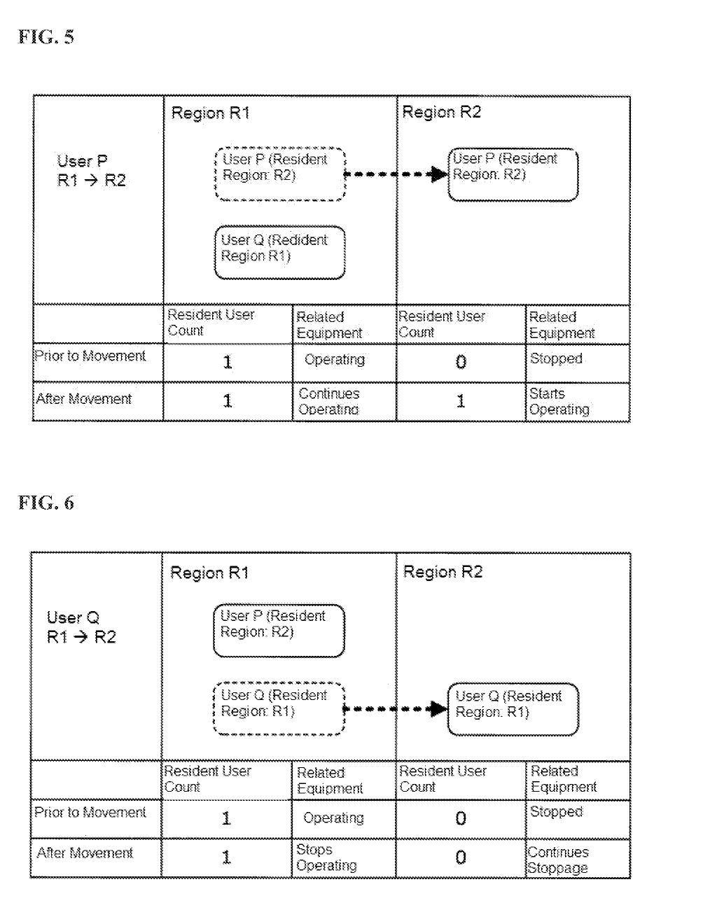

FIG. 5 is an explanatory diagram illustrating an example of the entry evaluation operation of the facility controlling system according to an example. Here a case wherein a user P enters into a region R2 from a region R1 is shown as an example.

First, in the state prior to the entry, in the region RI there is a user P, for whom the resident region is region R2, any user Q from the resident region is region R1, and there are no users in region R2. Consequently, the resident user count in region R1 is 1, and the resident user count in region R2 is 0. Moreover, the related equipment in region R are operating, and the related equipment in region R2 are stopped.

Thereafter, when the user P enters into region R2, the operation of the related equipment in the movement destination region R2 is started because the user P is a resident user of the movement destination region R2 and the movement destination resident user count prior to the entry is zero.

Moreover, the operation of the related equipment in the movement origin region R1 continues because the user P is not a resident user of the movement origin region R1, and because the movement origin user count after the user P enters into the region R2 is not zero, given the presence, in the movement origin region R1, of the user Q, who is a resident user of the movement origin region R1.

FIG. 6 is an explanatory diagram illustrating another example entry evaluation operation of the facility controlling system according to the example. Here a case wherein the user Q enters into region R2 from region RI will be shown as an example. First, in the state prior to the entry, in the region RI there is a user P, for whom the resident region is region R2, any user Q from the resident region is region R1, and there are no users in region R2, Consequently, the resident user count in region R1 is 1, and the resident user count in region R2 is 0. Moreover, the related equipment in region R1 are operating, and the related equipment in region R2 are stopped.

Thereafter, when the user Q enters into region R2, the operation of the related equipment in the movement destination region R2 is not started because the user Q is not a resident user of the movement destination region R2.

Moreover, the operation of the related equipment in the movement origin region RI is stopped because the user Q is a resident user of the movement origin region R1, and because the movement origin user count after the user Q enters into the region R2 is zero, given the presence, in the movement origin region R1 of only the user P, who is not a resident user of the movement origin region R1.

In this way, in the present example, the resident region of the user is obtained from the user information storing portion 44B, and the movement destination resident user count in the movement destination region of the user is obtained from the region information storing portion 44A, when the evaluation result by the evaluation processing portion indicates that entry is authorized, making it possible to instruct the equipment operation controlling portion 47 to start the operation of the related equipment in the movement destination region if the user is a resident user of the movement destination region and the movement destination resident user count prior to entry by the user was zero, thus making it possible to start the operation of the related equipment in the movement destination region only if a user who is a resident user of the movement destination region enters into a movement destination region wherein there is no resident user of the movement destination region present.

Doing so makes it possible to avoid starting the operation of the related equipment in the movement destination region when a user who is not a resident of the movement destination region enters into a movement destination region wherein there is no resident user of the movement destination region present, enabling the related equipment in the region to be operated more efficiently and more economically than in a case wherein the related equipment that is related to the region is operated automatically depending on whether or not an arbitrary user is present in the region.

Moreover, in the present example, the movement origin resident user count in the movement origin region of the user is obtained from the region information storing portion 44A when the evaluation result by the evaluation processing portion indicates that entry is authorized, making it possible to instruct the equipment operation controlling portion 47 to stop the operation of the related equipment in the movement origin region if the user is a resident user of the movement origin region and the movement origin resident user count after entry by the user is zero, thus making it possible to stop the operation of the related equipment in the movement origin region immediately if there ceases to be a resident user of the movement origin region present in the movement origin region.

Doing so makes it possible to avoid continuing the operation of the related equipment in the movement origin region when only a user who is not a resident user of the movement origin region is present in a movement origin region wherein there is no resident user of the movement origin region present, enabling the related equipment in the region to be operated more efficiently and more economically than in a case wherein the related equipment that is related to the region is operated automatically depending on whether or not an arbitrary user is present in the region.

A facility controlling system according to another example is explained next.

In the present example, the explanation is for a case wherein an entry evaluation is performed based on the movement destination resident user count when evaluating the entry of a user into a movement destination region.

In the present example, the evaluation processing portion 46 has a function for evaluating the entry of a user into a movement destination region as being non-authorized if the movement destination resident user count prior to entry by the user is zero and the user is not a resident user of the movement destination region when, at the time of an entry evaluation, the evaluation result based on the evaluation information would indicate entry authorization.

The other structures of the facility controlling system according to the present example are identical to those in the previous example, and thus detailed explanations thereof are omitted.

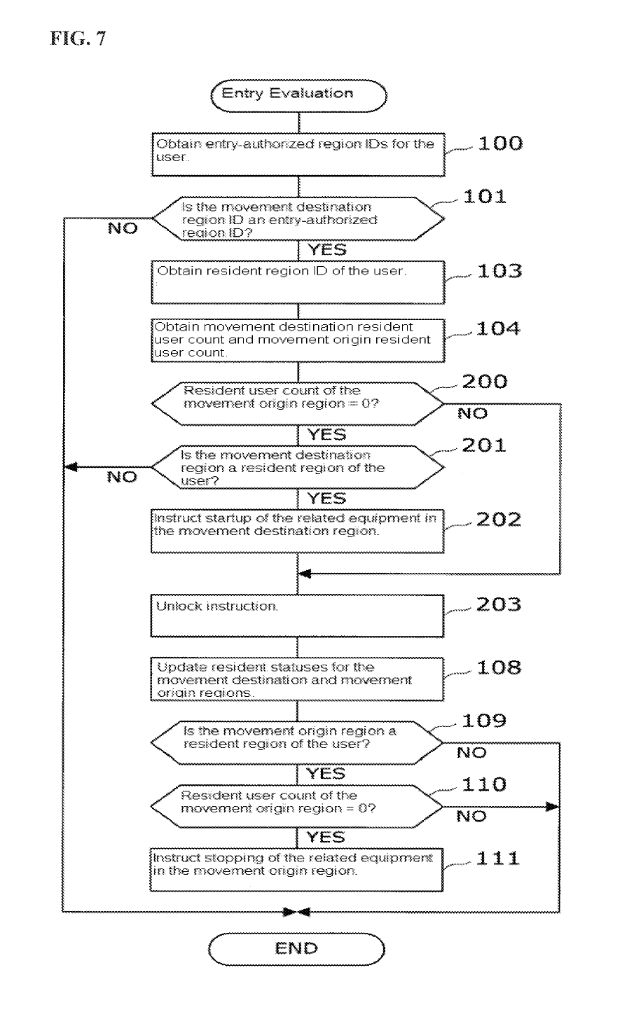

The entry evaluation operations of the facility controlling system according to the present example is explained next in reference to FIG. 7. FIG. 7 is a flowchart illustrating the entry evaluation operation of the facility controlling system according to another example, where those parts that are similar or identical to those in FIG. 4, described above, are assigned identical codes.

The evaluation processing portion 46 of the administering device 40 performs the entry evaluation processes of FIG. 7 in response to an evaluation request from a reader terminal 22, received by the communication LT portion 41 through the controlling device 30.

First the evaluation processing portion 46 receives, from the user information storing portion 44B, the entry-permitted region IDs for the user, based on the user ID that is included in the evaluation request that has been received (Step 100), and compares it to a movement destination region ID that indicates a region 20 corresponding to a door ID, received from the region information storing portion 44A based on the door ID that is included in an evaluation request that, similarly, has been received (Step 101).

If here the movement destination region ID is not included in the entrance-authorized region IDs (Step 101: NO), then the entrance of the user for the movement destination region is evaluated as being unauthorized, and the series of entry evaluating processes is terminated. Doing so causes the electric lock 23 of the corresponding door 21 to remain locked, so that the user is unable to enter into the movement destination region.

On the other hand, if the movement destination region ID is included in the entry-authorized region IDs (Step 101: YES), then the evaluation processing portion 46 obtains the resident region ID of the user from the user information storing portion 44B (Step 103) and obtains, from the region information storing portion 44A, the movement destination resident user count, which is the number of resident users in the movement destination region, and the movement origin resident user count, which is the number of resident users in the movement origin (Step 104).

Following this, if the movement destination resident user count prior to the entry by the user is zero (Step 200: YES) and the user is a resident user of the movement destination region (Step 201: YES), then the evaluation processing portion 46 evaluates that the entry of the user into the movement destination region is authorized, and, based on the related equipment IDs of the movement destination region obtained from the region information storing portion 44A, instructs the equipment operation controlling portion 47 to start the operation of the related equipment of the movement destination region (Step 202), and sends an unlock instruction to the electric lock 23 of the corresponding door 21 through a controlling device 30 from a communication I/F portion 41 (Step 203).

Doing so causes the operation of the related equipment in the movement destination region to be started by the equipment operation controlling portion 47, and the electric lock of the door 21 to be unlocked, enabling the user to enter into the movement destination region. Consequently, even when there is no resident user of the movement destination region present (prior to the entry, if the user who is entering is a resident user of the movement destination region, the evaluation is that the user is authorized to enter the movement destination region, and, accordingly, the operation of the related equipment in the movement destination region is also started.

On the other hand, if the movement destination resident user count prior to entry by the user is zero (Step 200: YES) and the user is not a resident user of the movement destination region (Step 201: NO), then the entrance of the user for the movement destination region is evaluated as being unauthorized, and the series of entry evaluating processes is terminated. Doing so causes the electric lock 23 of the corresponding door 21 to remain locked, so that the user is unable to enter into the movement destination region. Consequently, if there would be no resident user of the movement destination region present in the movement destination region even after the movement by the user, the evaluation is that entry by the user into the movement destination region is not authorized.

Moreover, if the movement destination resident user count prior to the entry by the user is not zero (Step 200: NO), then the evaluation processing portion 46 jumps to Step 203 without instructing the equipment operation controlling portion 47 to start the operation of the related equipment in the movement destination region, to thereby send an unlock instruction from the communication IF portion 41 through the controlling device 30 to the electric lock 23 of the corresponding door 21.

Doing so causes the electric lock of the door 21 to be unlocked, enabling the user to enter into the movement destination region. Consequently, when a resident user of the movement destination region is present in the movement destination region, the evaluation is that the user is authorized to enter the movement destination region, and, accordingly, the operation of the related equipment in the movement destination region will continue.

Thereafter, the evaluation processing portion 46 updates the resident user counts, in the region information storing portion 44A, of the movement destination region and the movement origin region relating to the entry by the user (Step 108). Following this, if the user is a resident user of the movement origin region (Step 109: YES), and the movement origin resident user count after the entry by the user is zero

(Step 110: YES), then the evaluation processing portion 46 instructs the equipment operation controlling portion 47 to stop the operation of the related equipment of the movement origin region based on the related equipment IDs of the movement origin region, obtained from the region information storing portion 44A (Step 111), and terminates the series of entry evaluation processes. As a result, the operation of the related equipment of the movement origin region is stopped by the equipment operation controlling portion 47 after the entrance by the user into the movement destination region, even if there is, in the movement origin region, a user who is not a resident user of the movement origin region.

On the other hand, if the user is not a resident user of the movement origin region (Step 109: NO), or the movement origin resident user count after the entry of the user is not zero (Step 110: NO), then the evaluation processing portion 46 terminates the series of entry evaluation processes without instructing the termination of operation of the related equipment in the movement origin region.

As result, if the status of the related equipment in the movement origin region prior to the entry is continued, for example, if a resident user remains in the movement origin region, the operation of the related equipment continues, and if the related equipment is not operating because there is no resident user in the movement origin region, the stopped state of operation of the related equipment continues.

FIG. 8 is an explanatory diagram illustrating an example of the entry evaluation operation of the facility controlling system according to another example. Here a case wherein a user P enters into a region R2 from a region R1 is shown as an example.

First, in the state prior to the entry, in the region R1 there is a user P, for whom the resident region is region R2, any user Q from the resident region is region R1, and there are no users in region R2, Consequently, the resident user count in region R1 is 1, and the resident user count in region R2 is 0. Moreover, the related equipment in region R1 are operating, and the related equipment in region R2 are stopped. Thereafter, when the user P enters into region R2, even though the movement destination resident user count prior to the entry is zero, still the evaluation is that entry of the user P into the movement destination region R2 is authorized because the user P is a resident user of the movement destination region R2.

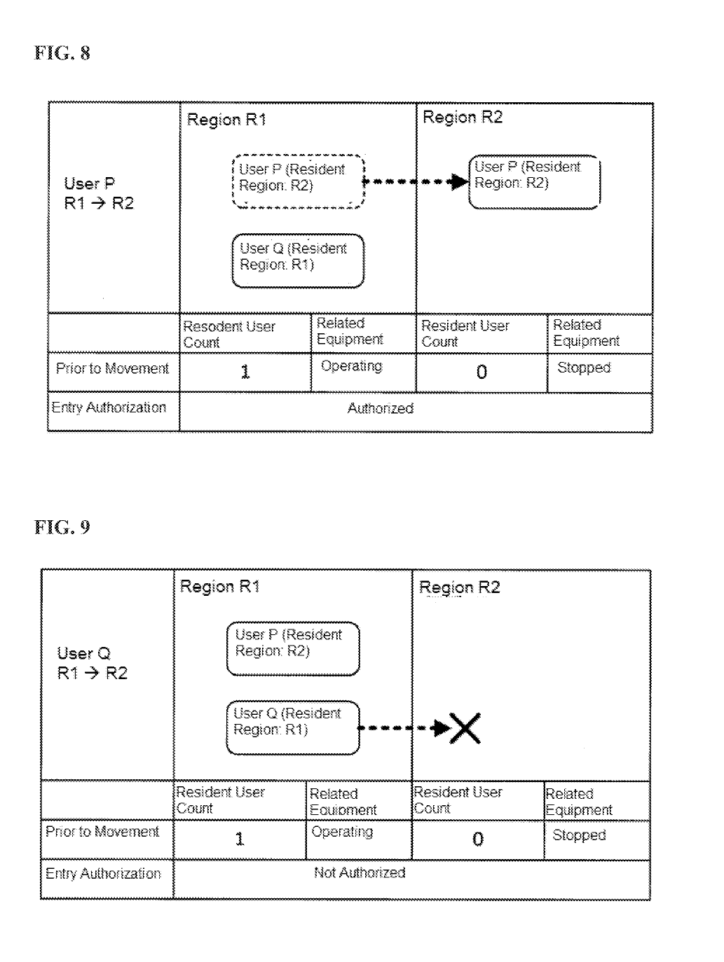

FIG. 9 is an explanatory diagram illustrating another example entry evaluation operation of the facility controlling system according to the other example. Here a case wherein the user Q enters into region R2 from region R1 is shown as an example.

First, in the state prior to the entry, in the region R1 there is a user P. for whom the resident region is region R2, any user Q from the resident region is region R1, and there are no users in region R2. Consequently, the resident user count in region R1 is 1, and the resident user count in region R2 is 0. Moreover, the related equipment in region R1 are operating, and the related equipment in region R2 are stopped.

Thereafter, when the user Q is entering into region R2, the movement destination resident user count prior to the entry is zero and the user Q is not a resident user of the movement destination region R2, so the evaluation is that entry of the user Q into the movement destination region R2 is not authorized.

In this way, in the present example, the entry of a user into a movement destination region is evaluated by the evaluation processing portion 46 as being non-authorized if the movement destination resident user count prior to entry by the user is zero and the user is not a resident user of the movement destination region when, at the time of an entry evaluation, the evaluation result based on the evaluation information would indicate entry authorization, thus enabling an evaluation that the entry of the user into the movement destination region is not authorized when there would be no resident user of the movement destination region present in the movement destination region even after the movement by the user.

Doing so makes it possible to permit entry of a user that is not a resident user of the movement destination region only when a resident user of the movement destination region is present in the movement destination region, making it possible to achieve entry evaluations with extremely high levels of security.

White the present invention was explained above in reference to forms of embodiment, the present invention is not limited by the forms of embodiment set forth above The structures and details of the present invention may be modified in a variety of ways, as can be understood by those skilled in the art, within the scope of the present invention.

1. A facility controlling system for controlling the operation of related equipment that is related to a region at a time of an entry evaluation into a region provided in the facility, comprising:
a region information storing portion storing, for each region for which entry is controlled, a resident user count that indicates the number of resident users, for whom the region is a resident region, present in the region;
a user information storing portion storing, for each user who uses a region, a resident region that indicates a region wherein the user is normally present, and evaluation information for evaluating entry authorization into the region:,
a reader terminal, provided in each region, sending an evaluation request for requesting an entry authorization evaluation for the user for the region in response to a user operation; and
an evaluation processing portion evaluating, in response to an evaluation request from a reader terminal, entry authorization of the user regarding the region based on evaluation information for the user Obtained from the user information storing portion, and instructing unlocking of an electric lock that is provided at the region and also updating, in the region information storing portion, resident user counts in a movement destination region and a movement origin region of the user, when the evaluation result is that entry is authorized; and
an equipment operation controlling portion controlling, for each region, operation of related equipment m coordination with use of that region;
wherein:
the evaluation processing portion, when the evaluation result indicates that entry is authorized, obtains a resident region of the user from the user information storing portion and obtains a movement destination resident user count, from the region information storing portion, of the movement destination region of the user, and if the user is a resident user of the movement destination region and the movement destination resident user count prior to entry by the user is zero, instructs the equipment operation controlling portion to start operation of the related equipment in the movement destination region,

2. The facility controlling system as set forth in claim 1, wherein:
the evaluation processing portion, when the evaluation result indicates that entry is authorized, obtains a movement origin resident user count, from the region information storing portion, of the movement origin region of the user, and if the user is a resident user of the movement origin region and the movement origin resident user after entry enter by the user will be zero, instructs the equipment operation controlling portion to stop operation of the related equipment in the movement origin region.

3. The facility controlling system as set forth in claim 1, wherein:
the evaluation processing portion, if the movement destination resident user count prior to entry by the user is zero and the user is not a resident user of the movement destination region when the evaluation result based on the evaluation information indicates that entry is authorized, evaluates the entry of a user into the region as being non-authorized.

4. A facility controlling method used in a facility controlling system tor controlling the operation of related equipment that is related to a region at a time of an entry evaluation into a region provided in the facility, comprising:
a region information storing step, storing, in a region information storing portion, for each region for which entry is controlled, a resident user count that indicates the number of resident users, for whom the region is a resident region, present in the region;
a user information storing step, storing, in a user information storing portion, for each user who uses a region, a resident region that indicates a region wherein the user is normally present, and evaluation information for evaluating entry authorization into the region;
an operating step, sending, via a reader terminal, provided in each region, an evaluation request for requesting an entry authorization evaluation for the user for the region in response to a user operation;
an evaluation processing step, evaluating, using an evaluation processing portion, in response to an evaluation request from a reader terminal, entry authorization of the user regarding the region based on evaluation information for the user obtained from the user information storing portion, and instructing the unlocking of an electric lock that is provided at the region and also updating, in the region information storing portion, resident user counts in a movement destination region and a movement origin region of the user, when the evaluation result is that entry is authorized; and
an equipment operation controlling step, controlling, using an equipment operation controlling portion, for each region, operation of related equipment in coordination with use of that region;
wherein:
the evaluation processing step, when the evaluation result indicates that entry is authorized, further includes the step of obtaining a resident region of the user from the user information storing portion and obtaining a movement destination resident user count, from the region information storing portion, of the movement destination region of the user, and if the user is a resident user of the movement destination region and the movement destination resident user count prior to entry by the user is zero, instructing the equipment operation controlling portion to start operation of the related equipment in the movement destination region.

5. The facility controlling method as set forth in claim 4, wherein:
the evaluation processing step, when the evaluation result indicates that entry is authorized, further includes the step of obtaining a movement origin resident user count, from the region information storing portion, of the movement origin region of the user, and if the user is a resident user of the movement origin region and the movement origin resident user after entry enter by the user will be zero, instructing the equipment operation controlling portion to stop operation of the related equipment in the movement origin region.

6. The facility controlling method as set forth in claim 4, wherein:
the evaluation processing step, if the movement destination resident user count prior to entry by the user is zero and the user is not a resident user of the movement destination region when the evaluation result based on the evaluation information indicates that entry is authorized, further includes the step of evaluating the entry of a user into the region as being non-authorized.
